(19) United States
(12) Patent Application Publication
(10) Pub. No.: US 2013/0070838 A1
(43) Pub. Date: Mar. 21, 2013

(54) ERROR TOLERANT VIDEO TRANSMISSION SCHEME

(71) Applicant: Victor Cherepanov, Novosibirsk (RU)

(72) Inventor: Victor Cherepanov, Novosibirsk (RU)

(21) Appl. No.: 13/521,591

(22) PCT Filed: Jan. 13, 2010
(86) PCT No.: PCT/RU10/00006

§ 371 Date: Nov. 8, 2012

(51) Int. Cl. H04N 7/26

(52) U.S. Cl. 375/240.01; 375/E07.026

(57) ABSTRACT

A GOP methodology using multiple sub sequences to convey a sequence of video frames is provided herewith.

### TECHNICAL FIELD

The present invention relates generally to video processing and in particular, to methods and devices for encoding video for transmission such as over a network.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram illustrating a contemporary approach for interdependent GOP video frame transmission.

FIG. 2 is a block diagram to illustrate how video may be transmitted in accordance with some embodiments of the invention.

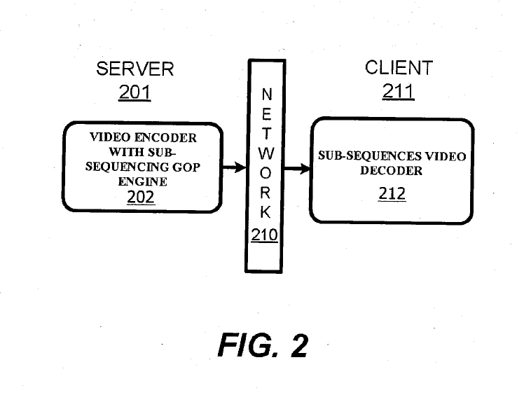

FIG. 3 is a diagram illustrating how video may be transmitted using frame sub-sequences in accordance with some embodiments.

### DETAILED DESCRIPTION

The demand for remote, high quality video transmission, is becoming ever more ubiquitous. For example, efficient video stream transmission methodologies are needed for real-time or quasi real-time applications such as video conferencing, video-on-demand, digital television and many other applications. Most approaches use so-called lossy compression video transmission techniques to satisfy timing constraints in low bandwidth environments. With such techniques, information is inherently lost, but the reduction in video file size can generally be greater in value than video viewing deficiencies experienced by users.

Lossy video-coding standards employing inter-frame dependence are commonly used. For example, with so-called group of picture (GOP) interdependent framing schemes (e.g., MPEG-4), reference frames (commonly referred to as “I” frames) convey most, if not all, of a scenes visual information for a given frame image. They are dispersed within other frames (so-called “P” and “B” frames). The P-frames are forward predicted frames and B-frames are bi-directional predicted frames. Both P-frames and I-frames may be referenced by other, later in sequence frames. A B-frame is encoded relative to the past reference frame, the future reference frame, or both frames.

The P and B frames reference the I-frames for much of their scene information. They essentially carry just the parts of a scene that change from the relevant I-frame. Accordingly, they can be significantly smaller (data size) than the I-frames and thus enable video sequences to be greatly compressed.

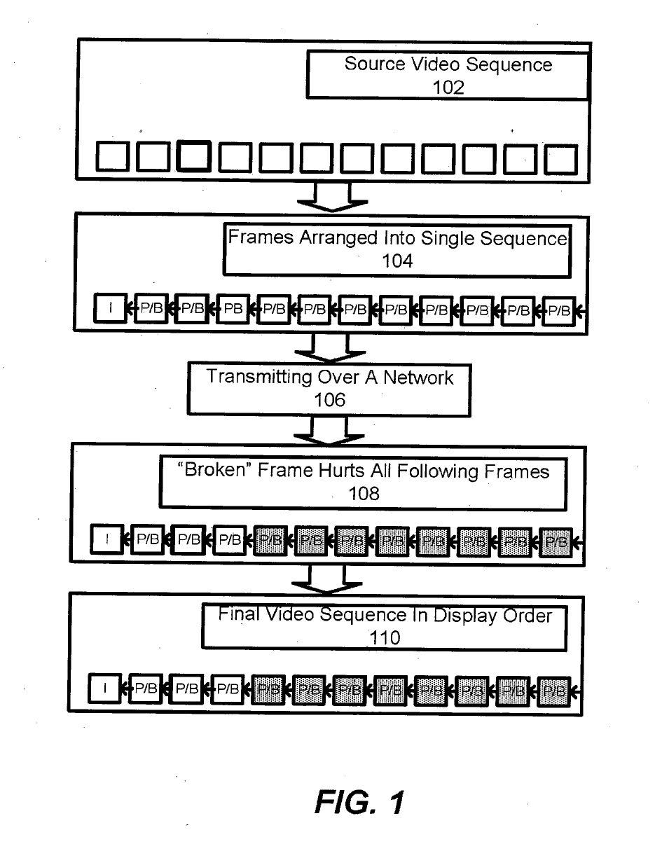

FIG. 1 graphically shows how a source video file is currently encoded and organized into group of picture (GOP) sequence of frames using the interdependent I, P, and B frames. Block 102 represents the source stream of actual pictures from the video source making up the video to be encoded and transmitted. At 104, the frame pictures are encoded into the GOP sequence of interdependent I, P, and B frames. The frames are essentially ordered into a single sequence in accordance with the video picture sequence itself. it is worth noting that any P or B frame in the in this depiction) are depicted in block 306. While three sub sequences are used in this example, for the general methodology, the source video frame sequence is divided into two or more sub sequence groups (sub sequences). The use of more sub sequences typically results in less distortion, etc., but may be more difficult to timely put back together in the decoder. Thus, a compromise between these countervailing factors should be considered. Any suitable sub sequence number may be employed, depending on various design considerations such as average video file size, desired resolution/quality, and hardware capability, to mention just a few.

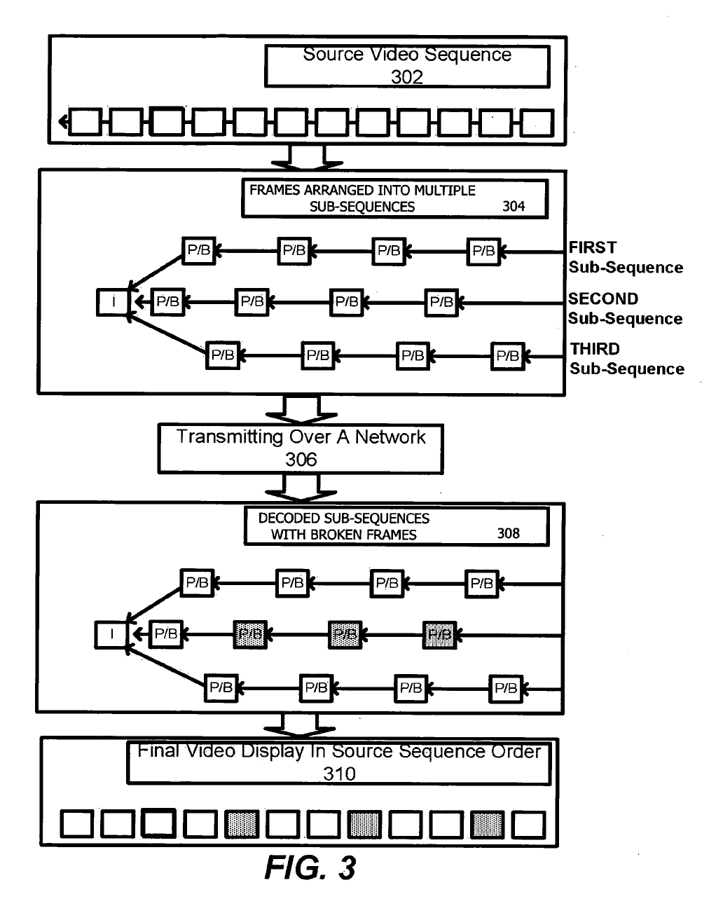

As discussed above, inter-frame encoding within each sub sequence should, for the most part, just reference other frames from the same sub sequence. Again, an exception to this constraint is when leading frames in the various sub sequences reference a common, leading reference frame. This is shown in blocks 304 an 308 of FIG. 3. In other words, frames in a sub sequence should only reference other frames from that same sub sequence, except, for example, if they reference a common leading reference frame.

In some embodiments, the sub sequence/frame assignment is done by sub sequence alternation when dividing the frames from the source video frame sequence into the sub sequences. For example, with the use of two sub sequences and an H264 standard, the encoder may be configured to divide the source file frames into two sub sequences. With the use of the flexible H264 frame assignment feature, for example, the encoder may assign “odd” frames to an “odd” frame sub sequence and “even” frames to an “even” frame sub sequence. From there, it would then assign inter-frame referencing relationships for the odd frames to reference other odd frames and for the even frames to reference other even frames. It then generates an H264 stream and transmits it over the network.

As another example, for a three sub sequence scheme (shown in FIG. 3), an alternating three group (sub sequence) scheme may be employed. The first frame could be assigned to a first sub sequenced, the second frame assigned to the second sub sequence, the third frame to the third sub sequence, the fourth frame back to the first sub sequence, the fifth frame to the second sub sequence, and so on. That is, frame number N would go to the sub sequence that is the remainder of N+[the number of utilized sub sequences].

With this example, in the decoder, the mirror opposite process could be applied in order to restore the original frame order. That is, the decode process, as far as un-wrapping the frames from the sub sequences, would typically be inverse to the encoding frame assignment process. Thus, with the example above using three sub sequences, the first frame comes from the firs frame of sub sequence 1, the second overall frame from the first frame of sub sequence 2, the third frame from the first frame of sub sequence 3, the fourth frame from the second frame of sub sequence 1, the fifth frame from the second frame of sub sequence 2, and so on. A benefit of using a compression standard with flexible frame referencing capability (such as H264) is that with such a feature, decoders would not have to be designed differently to accommodate implementations of the presented sub-sequencing methodologies. They would unpack the frames, as just discussed, without knowing or caring that they were facilitating a sub-sequencing method as taught herein

With the use of such a multi sub-sequencing encoding/decoding process, the impact from a defective sub sequence or defective group of frames in a sub-sequence is minimized, which allows for the video quality to remain high even if certain frame losses or corruption occurs during transmission. For example, imagine the case where a sub sequence gets a broken frame. The broken frame affects frames from its sub sequence that follow it but not those in the other sub sequences. This is illustrated with the shaded frames in block 308. The frames in the other sub sequences don't depend on the broken sub sequence(s), which is why the other sub sequences are decoded without problems, as represented in block 310.

Thus, if an error occurs during transmission, and a frame gets decoded with visible artifacts, frames from the “broken” sub sequence will be interleaved with healthy frames coming from the other sub sequence. It may look like a little blinking on the screen but not nearly as deficient as otherwise may be, WITH overall visual quality not considerably suffering.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments. For example, while an encoder transmitting video files using sub-sequences, as taught herein, is shown transmitting the frames over a network, it should be appreciated that a network may not be used in all applications, for example, the inventive encoding scheme may be employed for files conveyed through storage media such as with video discs or other storage approaches.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

1. A chip, comprising:
a graphics processor to encode a sequence of video frames by associating the frames into two or more different sub sequences.

2. The chip of claim 1, in which the two or more sub sequences are to be transmitted over a network.

3. The chip of claim 2, in which the sub sequences are to be conveyed in separate network packets.

4. The chip of claim 1, in which the frames from the video frame sequence are distributed through the two or more sub sequences so that each sub sequence includes frames from throughout the beginning to the end of the source video frame sequence.

5. The chip of claim 1, in which three sub sequences are used.

6. The chip of claim 1, in which an MPEG-4 encoding scheme is used.

7. An electronic device, comprising:
a graphics processor having a decoder to decode two or more different sub sequences for a source video frame sequence into a displayable video format.

8. The device of claim 7, comprising a network interface to receive the two or more sub sequences over a network.

9. The device of claim 8, in which the sub sequences are to be conveyed in separate network packets.

10. The device of claim 7, in which the frames from the source video frame sequence are distributed through the two or more sub sequences so that each sub sequence includes frames from throughout the beginning to the end of the source video frame sequence.

11. The device of claim 7, in which an MPEG-4 decoding scheme is used.

12. The device of claim 11, in which an H264 compression standard is to be used.

13. A method, comprising:
dividing a source video frame sequence into two or more sub-sequences; and
assigning interdependent frame references for frames within each sub-sequence substantially only to other frames within the same sub-sequence.

14. The method of claim 13, comprising assigning a reference relationship from a frame in each sub sequence to a common reference frame to be ahead of the sub-sequences.

15. The method of claim 14, wherein the common reference frame is outside of all of the sub sequences.

16. A server, comprising:
an encoder to divide a source video frame sequence into two or more sub-sequences, and to assign interdependent frame references for frames within each sub-sequence substantially only to other frames within the same sub-sequence.

17. The server of claim 16, wherein assigning includes assigning a reference relationship from a frame in each sub sequence to a common reference frame to be ahead of the sub-sequences.

18. The server of claim 17, wherein the common reference frame is outside of all of the sub sequences.

19. The server of claim 17, in which an H264 compression standard is employed.
